(19) United States
(12) Patent Application Publication
(10) Pub. No.: US 2014/0140589 A1
(43) Pub. Date: May 22, 2014

(54) MEMORY SENSITIVE MEDICAL IMAGE BROWSER

(71) Applicant: GENERAL ELECTRIC COMPANY, Schenectady, NY (US)

(72) Inventor: Jason Dieter Klotzer, Woodside, NY (US)

(73) Assignee: General Electric Company, Schenectady, NY (US)

(21) Appl. No.: 13/683,389

(22) Filed: Nov. 21, 2012

(51) Int. Cl. G06T 7/00

(52) U.S. Cl. CPC G06T 7/0012
USPC 382/128

(57) ABSTRACT

Certain examples provide systems and methods for memory and/or device-sensitive image viewing. An example method includes receiving a request for a medical image study display at a browser on a client device. The example method includes determining a size of the image study. The example method includes determining available space on the client device for image data storage. The example method includes determining a starting point for display of the image study via the browser. The example method includes pre-loading one or more images on the client device based on the starting point, image study size, and available space on the client device.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Prior to the rapid onset of digital imaging, patient images were “printed” to film. The film was “hung” and viewed by radiologists, who would then dictate a report. Reports were transcribed by individuals ranging for administrative staff to medical transcriptionists and sent to ordering physician via mail or fax. Critical results were delivered by phone or pager and business statistics were managed via paper reports and spreadsheets.

As information systems for radiology came to market, the first commercially available solutions addressed the needs of the radiologist and the radiology department. These included Radiology Information Systems (RIS) and dictation transcription systems. RIS systems managed the ordering, scheduling, patient and management reporting processes while radiologists were still reading from film.

As modalities started to support the digital display of images on workstations connected to the acquisition device, Picture Archiving and Communications Systems (PACS) came to market. These centrally store images and provide radiologists with the tools to read studies on networked computer monitors, replacing both film and modality workstations.

Over time, the needs of the market have evolved from supporting specialized radiologist workflows to supporting the open and dynamic needs of the enterprise and the community. The vendor community has added systems to manage the need for advanced technologies for better diagnosis; the sharing of images between providers and organizations; to support collaboration between radiologists, physicians and teams providing care for the patient; to close the loop on reporting of critical results and manage the growing storage requirements. Often these are disparate, best-of breed systems that may or may not interoperate, increasing cost and decreasing productivity.

### BRIEF SUMMARY

Certain examples provide systems and methods for memory and/or device-sensitive medical image viewing.

Certain examples provide a system including a medical image viewer. The example medical image viewer is configured to receive a request for a medical image study display at a browser on a client device. The example medical image viewer is configured to determine a size of the image study. The example medical image viewer is configured to determine available space on the client device for image data storage. The example medical image viewer is configured to determine a starting point for display of the image study via the browser. The example medical image viewer is configured to pre-load one or more images on the client device based on the starting point, image study size, and available space on the client device.

Certain examples provide a tangible computer-readable storage medium including computer program code to be executed by a processor, the computer program code, when executed, to implement a method. The example method includes receiving a request for a medical image study display at a browser on a client device. The example method includes determining a size of the image study. The example method includes determining available space on the client device for image data storage. The example method includes determining a starting point for display of the image study via the browser. The example method includes pre-loading one or more images on the client device based on the starting point, image study size, and available space on the client device.

Certain examples facilitate a method including receiving a request for a medical image study display at a browser on a client device. The example method includes determining a size of the image study. The example method includes determining available space on the client device for image data storage. The example method includes determining a starting point for display of the image study via the browser. The example method includes pre-loading one or more images on the client device based on the starting point, image study size, and available space on the client device.

### BRIEF DESCRIPTION OF SEVERAL VIEWS OF THE DRAWINGS

FIG. 1 illustrates a flow diagram of an example method to provide memory-sensitive image browsing independent of a client device.

FIG. 2 illustrates a flow diagram for an example method to stream lossless image data to a client device.

FIG. 3 illustrates an example zero footprint viewer.

FIG. 4 is a block diagram of an example processor system that may be used to implement systems and methods described herein.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EMBODIMENTS

### I. Overview

In certain examples, a unified viewer workspace for radiologists and clinicians brings together capabilities with innovative differentiators that drive optimal performance through connected, intelligent workflows. The unified viewer workspace enables radiologist performance and efficiency, improved communication between the radiologist and other clinicians, and image sharing between and across organizations, reducing cost and improving care.

The unified imaging viewer displays medical images, including mammograms and other x-ray, computed tomography (CT), magnetic resonance (MR), ultrasound, and/or other images, and non-image data from various sources in a common workspace. Additionally, the viewer can be used to create, update annotations, process and create imaging models, communicate, within a system and/or across computer networks at distributed locations.

In certain examples, the unified viewer implements smart hanging protocols, intelligent fetching of patient data from within and outside a picture archiving and communication system (PACS) and/or other vendor neutral archive (VNA). In certain examples, the unified viewer supports image exchange functions and implements high performing streaming, as well as an ability to read across disparate PACS without importing data. The unified viewer serves as a “multi-ology” viewer, for example.

In certain examples, a native reading worklist is provided via the unified viewer. The worklist is intuitive and user defined and can include multi-identifier, multi-document, and multi-institution, for example.

Certain examples provide workflow integration via the unified viewer. Workflow integration includes integration with reporting systems, worklists, voice recognition (VR), electronic medical records (EMR); exporting of measurements; exporting of exam notes; thin slice management; etc.

### II. Memory-Sensitive Image Browsing

In certain examples, the memory-sensitive image browsing is facilitated (e.g., by a zero footprint viewer). By tracking an amount of resources used and by paging image data off of a server, image browsing can be zero foot print and memory-sensitive to the client browser. Digital Imaging and Communications in Medicine (DICOM) image studies can be very large, making browsing of DICOM image studies difficult or impractical via the Web. While a standard web browser has approximately two gigabytes of memory at its disposal, some of which is used by the browser itself as well as other web pages that are currently loaded or cached. However, a large DICOM study, such as a 10 k CT image study, occupies approximately twice this amount to be stored directly in memory.

In certain examples, resources used in the web client browser/viewer are tracked at all times. Resources include meta information that is stored, raw pixel information, compressed data, non-image objects, etc. While tracking this information, information that is being viewed can be loaded ahead of time (e.g., pre-fetch by a ZFP viewer).

For example, if a user wants to view a 1000 slice CT series from a large CT study, the viewer assumes that the user has to pick a starting point in that series. For example, it can be assumed that the user will start at the beginning of the series and scroll toward the end. Since the user can only scroll at a certain rate and since an amount of space available in memory on the web client is tracked (e.g., a hard coded value for the web page), the viewer determines approximately how many images to preload in the web viewer so that the user has a fluid experience when scrolling through the images. When the user gets close to the end point of images that are preloaded in the viewer, the viewer “intelligently” purges the images in the series that are further from the images which are displayed (and in the client cache) and pre-caches more data for display. In certain examples, this process is continuous (or at least substantially continuous) while the user is actively viewing a study. The monitoring and pre-fetching process is very fast, since the server keeps all image information for this study loaded while the user session is active via the viewer. By paging with the server to process and organize data at the server and display it to the client, the viewer can support user viewing of extremely large DICOM image sets without special capability in the user's web browser.

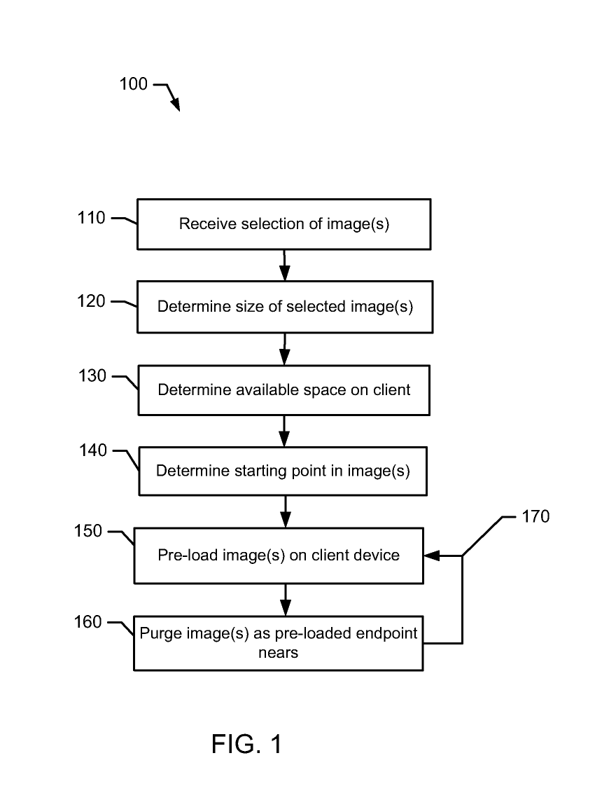

FIG. 1 illustrates a flow diagram of a method 100 to provide memory-sensitive image browsing independent of a client device. At block 110, a selection of an image or image series is received. For example, a user selects a study for retrieval and review via a tablet computer. At block 120, a size of the selected image(s) is determined.

At block 130, data storage space and/or other resource availability on the client device is determined. For example, an amount of cache and/or other memory space currently available on the user's tablet is determined. In certain examples, other conditions affecting available memory and/or browser performance can be identified on the client device (e.g., other programs running on the client device, other memory constraints, available bandwidth, available processing power, etc.).

At block 140, a starting point in the selected image(s) is determined. For example, the user may have selected an image part-way through an image series, or the user may have selected an image study without specifying a starting point such that the system can assume that the user is beginning with the first image in the series, etc. At block 150, based on the starting point, one or more images are pre-loaded on the client device based on one or more factors. For example, starting point, size, available space, other client device and/or connection conditions, etc., are factored in to determine which and/or how many images are to be pre-loaded on the client device.

At block 160, when the image viewing nears an end point of images that are preloaded in the viewer, the viewer “intelligently” purges the images in the series that are further from the images which are displayed (and in the client cache) and, at block 170, pre-caches more data for display. Purging and further pre-loading is based on a preconfigured size of the client cache as well as a type of images being displayed, for example. The process 100 continues as the user requests and/or views additional images such that the user's viewing experience on the client device is improved while not overburdening the client device.

### III. Form Factor-Based Streaming

Certain examples provide form factor-based streaming. For example, based on an available size of a client device (e.g., an available display area on a client device such as a desktop computer, laptop computer, tablet computer, smartphone, etc.), a resolution-compressed image is first transmitted for display while a full lossless diagnostic-quality image is downloaded in the background.

While an image browser can retrieve an image from storage on a server and then scale that image to the available viewport, certain examples provide a more efficient, more accurate transmission and rendering, particular for mobile and/or other smaller-screened client devices to view high-resolution images. In order to view large resolution DICOM images, a viewer (e.g., a ZFP viewer) requests images for the client device based on the form factor or exact viewport in which the client device is to display the image. For example, if the image being retrieved for display on a mobile or handheld is a computed radiography (CR) mammography image, such an image typically has a much larger “normal” or default display size than that of a handheld device. For example, such an image can be an order of magnitude larger (e.g., 1 megapixel (Mpxl) versus 10 Mpxl).

In this situation, a streaming component receives a request from the client device including a specific size of the viewport in which the image will be displayed. On the server, the image is resized before the image is transmitted to the client. Then, the properly sized pixels are sent over to the client device for display with no scaling on the client device necessary. By sizing correctly at the server, bandwidth and resources can be saved for the client device.

In certain examples, lossless image data can be viewed at the client device. In order to view a lossless image, the client device is to have the original pixel data of the image. Original image pixel data can be provided through a transcoding method (such as compression/decompression), through raw transfer of data, etc.

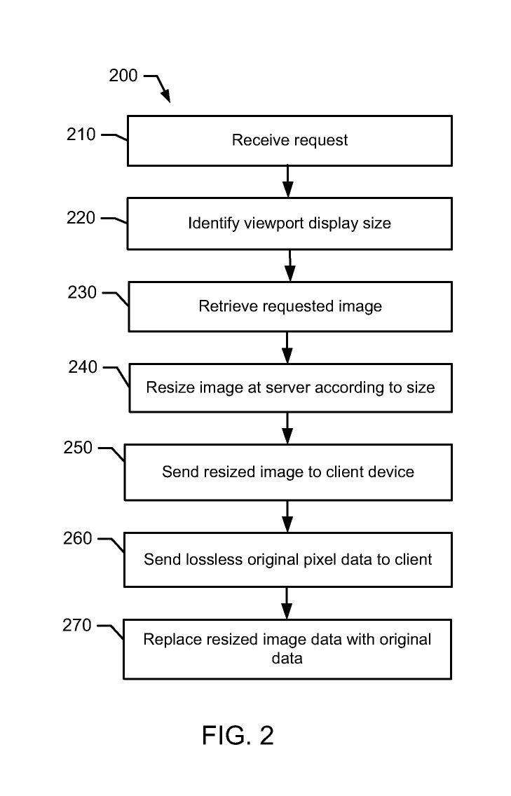

FIG. 2 illustrates a flow diagram for an example method 200 to stream lossless image data to a client device. At block 210, a request for an image is received at the streaming component (e.g., passed to an image data delivery client and then to an image data delivery system) from a client device (e.g., a web client). The request from the client includes a viewport display size available for the image. At block 220, the viewport display size is identified from the request by the image streaming component(s).

At block 230, the requested image is retrieved (e.g., from an enterprise archive, etc.). At block 240, the image is resized by the image streaming component(s) according to viewport size/resolution requested. At block 250, the specifically sized image for the resolution/viewport size requested is sent to the client device. In certain examples, when the specific resolution and original image dimensions have a negligible difference, then the original image is sent to the client.

At block 260, lossless, compressed original pixel data (e.g., portable network graphics (PNG) data, graphics interchange format (GIF) data, etc.) is sent from server to client. By sending the original pixel data, when a user zooms an image on the client device, the original pixel data is used to maintain accuracy for higher zoom rates as well as for measurements, etc.

At block 270, once the client device has received the full lossless image pixel data, the resolution compressed image sent at block 250 can be “upgraded” to (e.g., replaced with) the original pixel information. Upgrading or replacement of image data with higher quality/resolution data can occur without direct user interaction, for example. In certain examples, as soon as the cache has the lossless image, if there is a lossy visible image that corresponds to this image, the lossy image is replaced. Using the example method 200, small client devices can be used to browse large images. In certain examples, by providing an initial image, a user can begin review, and, when the user would like to manipulate the pixel information of the image directly, the lossless, original pixel information should be available on the client device.

For example, a 10 k resolution compress version of a 100 k image is initially provided for review, while the full 100 k image is being downloaded. Once the full resolution image data has been downloaded, it can be displayed, manipulated, etc.

### IV. Zero Footprint Medical Image Viewer

Certain examples provide systems, methods, and apparatus for a zero foot print (ZFP) viewer and/or ZFP viewing by which memory- and/or client device-sensitive image display can be facilitated. The ZFP viewer can display medical images, such as Digital Imaging and Communications in Medicine (DICOM) images, for example. In certain examples, the ZFP viewer can be implemented using Hyper Text Markup Language 5 (HTML5).

In certain examples, having zero footprint can be defined as no administrator rights or special configuration changes required to install and use the application (e.g., radiologist viewer and/or clinician viewer, etc.), providing the application to run on multiple browsers (e.g., Internet Explorer™, Firefox™, Safari™, Chrome™, etc.) and on multiple operating systems (Microsoft™ Windows, Apple OS, iOS™, Android™, etc.), providing portability to work on mobile platforms and a variety of device display sizes, require minimal or reduced computing resources (e.g., processor, memory, etc.) at the client, have acceptable performance on low bandwidth connections, etc.

The ZFP viewer can facilitate image viewing and exchange. For example, DICOM images can be viewed from a patient's longitudinal patient record in a clinical data repository, vendor neutral archive, etc. A DICOM viewer can be provided across multiple PACS databases with display of current/priors in the same framework, auto-fetching, etc.

In certain examples, the ZFP viewer is implemented based on a client framework that is able to work with multiple backend architectures. For example, a common interface, icons, annotations, terminology, tools, behaviors, etc., can be provided. An open application programming interface (API) can facilitate multiple bi-directional integrations with external systems such as reporting, EMR, VR, LDAP, etc.

Zero footprint and zero or silent deployment can be facilitated by server-side rendering of images. For example, image processing of advanced applications can occur on the server, rather than the client.

Additionally, events can be synchronization across embedded application. Logs can be generated for learning, indexing, auditing of the user activities, etc.

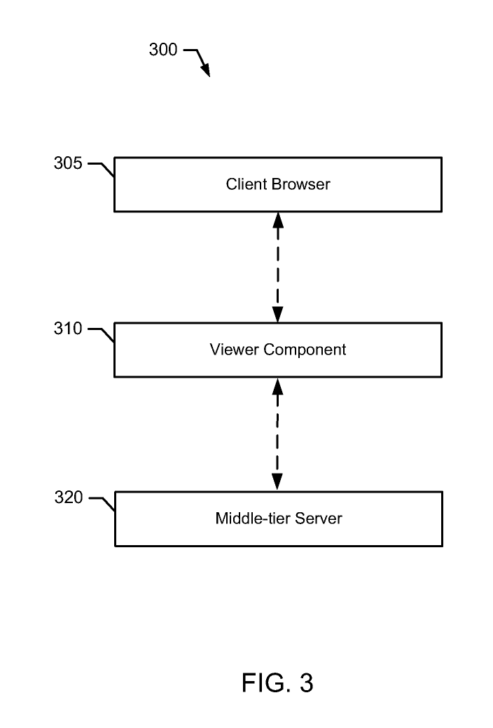

FIG. 3 illustrates an example ZFP viewer 300. The example ZFP viewer 300 is a DICOM medical image viewer that does not require any client installation or downloads of any component, and can run on virtually any hardware that is able to support an HTML5 browser (e.g., all modern hardware and operating systems). The flexibility and lack of client footprint provided by the ZFP viewer 300 is accomplished by providing several components in the viewer 300. The example ZFP viewer system 300 of FIG. 3 includes a viewer component 310 and a middle-tier server 320 providing image content and facilitating display and manipulation of the content at a client browser 305.

The viewer component 310 is the rendering/manipulation component of the ZFP viewer 300 (e.g., a rendering and manipulation engine for the ZFP HTML5 browser). In certain examples, the viewer component 310 uses HTML5 canvas element(s) to facilitate dynamic, scriptable rendering of shapes, images, and/or other graphical elements. In certain examples, the viewer component 310 is also able to render using Web Graphics Library (WebGL). Thus, the viewer engine 310 can provide a variety of dynamic two-dimensional (2D) and/or three-dimensional (3D) renderings for viewing (and interaction) by a user via the ZFP viewer 300.

The middle-tier server 320 drives conversion of image data to a format for viewing (e.g., a browser-friendly or browser-convenient format). The middle-tier server 320 supports transcoding of image data, such as DICOM data, for display via the viewer component 110. For example, the middle-tier serve 320 facilitates transcoding of image pixels, such as transcoding between DICOM-centric compression format(s) (e.g., Joint Photographic Experts Group committee 2000 (JPEG2000) image compression and coding format, etc.) and format(s) more suitable for modern browsers (e.g., Portable Network Graphics (PNG) image format). For non-image object and meta information, the middle-tier server 320 converts binary-based formats to browser-convenient formats, such as JavaScript Object Notation (JSON), etc.

In certain examples, transcoding is a direct digital-to-digital data conversion of one encoding to another. By facilitating transcoding at the middle-tier server 320, the viewer component 310 and the ZFP viewer 300 as a whole does not have to require a client device (e.g., a phone, tablet computer, laptop computer, desktop computer, etc.) to support a particular file format. Through transcoding, the middle-tier server 320 facilitates operation on a client device having a limited storage capacity and/or by occupying limited space for viewing on the client device regardless of how much space is actually available on the client. Transcoding by the middle-tier server 320 can facilitate conversion of old, incompatible, and/or obsolete data formats to a format suitable for viewing via the viewer component 310. Transcoding can be performed during search and/or presentation of image and/or non-image files, for example. Transcoding can be a lossy or a lossless process, for example. For example, transcoding can be lossless if the input is losslessly compressed and the output is either losslessly compressed or uncompressed. The process of lossy-to-lossy transcoding introduces varying degrees of generation loss.

In certain examples, the middle-tier server 320 performs a two-phase transcoding. First, a data file is decoded into an intermediate, uncompressed format. Second, the intermediate, uncompressed format is encoded into a target format.

In certain examples, data can be re-encoded in the same format for editing, lower bitrate, image scaling, etc. For example, for image editing of a JPEG image, the image file is decoded, edited, and re-encoded via the viewing component 310 and the middle-tier server 320.

In certain examples, files can be transrated to a lower bitrate. Transrating is a process similar to transcoding in which files are coded to a lower bitrate without changing formats. Transrating can include sample rate conversion, for example, but may use a same sampling rate with higher compression. By transrating, media can fit in a smaller storage space, over a lower bandwidth channel, etc.

The middle-tier server 320 can also facilitate image scaling for the viewing component 310. Changing image size is known as transsizing and can be used, for example, if an output resolution differs from a resolution of the media. Imaging scaling can be facilitated by the middle-tier server 320 on playback, via re-encoding, as part of transrating, etc.

Thus, the middle-tier server 320 can employ transcoding to help ensure proper display of content on a diverse variety of devices. The middle-tier server 320 provides an intermediate state of content adaptation to help ensure that source content can be displayed on a target device. In certain examples, the middle-tier server 320 provides real-time (or near real-time) transcoding in a many-to-many format (e.g., “any” input format to “any” output format) to provide search of, display of, and interaction with image and/or other content on a variety of devices via the ZFP viewer 300.

In certain examples, the ZFP viewer facilitates WebSockets-based DICOM image streaming. For example, an image's original format can be maintained through retrieval and display via the ZFP viewer. Certain examples provide programmable workstation functions using a WebSockets transport layer. Certain examples provide JavaScript remoting function translation over WebSockets.

Certain examples provide memory-sensitive image browsing via the ZFP viewer. For example, an amount of resources used can be tracked, and data can be paged off of the server.

Certain examples provide form factor-based streaming technology via the ZFP viewer. For example, based on an available size of a client device, a resolution compressed image is sent to the client viewer for first display while the full lossless image is downloaded in the background.

Certain examples provide scalable vector graphics (SVG) based DICOM grayscale softcopy presentation states (GSPS) for the Web via a ZFP viewer.

Certain examples provide a multi-level image cache middle tier. For example, a middle tier can be provided for data storage so as to avoid storing a large amount of information on the client side.

Certain examples provide an “intelligent” Web browser client capability workflow.

In certain examples, “memory sensitive” image browsing is facilitated by tracking an amount of resources used and paging requested image data off of the server to send to the browser. In addition to keeping track of an amount of memory used, a receiving client device is analyzed to determine whether the client device is capable of processing a given type of image, for example.

Additionally, form factor-based streaming technology provides, based on available client device characteristics including size (form factor), an initial image compressed at a first resolution for viewing while a full lossless medical diagnostic quality image is downloaded in the background. In certain examples, by accounting for a client device's form factor when streaming image data, images can be rendered on the server for delivery to and display on a device that are specific to the size and/or other characteristic of the device.

For example, if the client device is a handheld or mobile device (e.g., a smart phone, a tablet computer, etc.) and a mammography image (e.g., 8-10 megabytes in size) is selected for display, the user will not typically be able to view the image in a timely manner on the device. However, by facilitating communication between the client device and the server, the client can provide the server with a desired display port size, and the server can create a progressively compressed resolution image. The resulting image can be sent to the client to be displayed in a lowest resolution for the viewport size on the client. The remainder of the data for the image can be transmitted to the client in the background while the user is viewing the lower resolution image on the client device. Thus, a user flexibly receives an appropriate resolution for a type of client device being used to display the image.

In certain examples, scaled and vector graphics (e.g., SVG-based DICOM GSPS) allows tracking of a data plane using eXtensible Markup Language (XML). Vector graphic coordinates can be represented using XML, and GSPS can be displayed for one or more images. For example, a PACS viewer creates a DICOM GSPS object. A ZFP viewer implements SVG. By encapsulating GSPS in an SVG object, the GSPS can work directly with the image in a ZFP browser in XML. With SVG, annotation can be shown with an SVG parser available in the ZFP viewer. The annotation can be overlaid on the image, and the browser knows how to display the annotation with respect to the image.

### V. Conclusion

Thus, certain examples provide systems and methods for memory and/or device sensitive image viewing and interaction. Certain examples facilitate such viewing and interaction via a zero footprint platform and viewer that facilitates display, manipulation, reformatting, etc., of medical images (e.g., DICOM medical images) without a requirement for client installation, download of viewer component(s) at the client, etc., and which can run on virtually any hardware that is able to support an appropriate browser (e.g., an HTML5 browser). Certain examples provide a viewer component to facilitate image rendering and manipulation; a middle-tier server to support transcoding of data (e.g., DICOM data) for image pixels, metadata, and non-image objects. Using this novel architecture, efficient web based browsing of DICOM image studies can be accomplished without the addition of any extra components at the client system, for example.

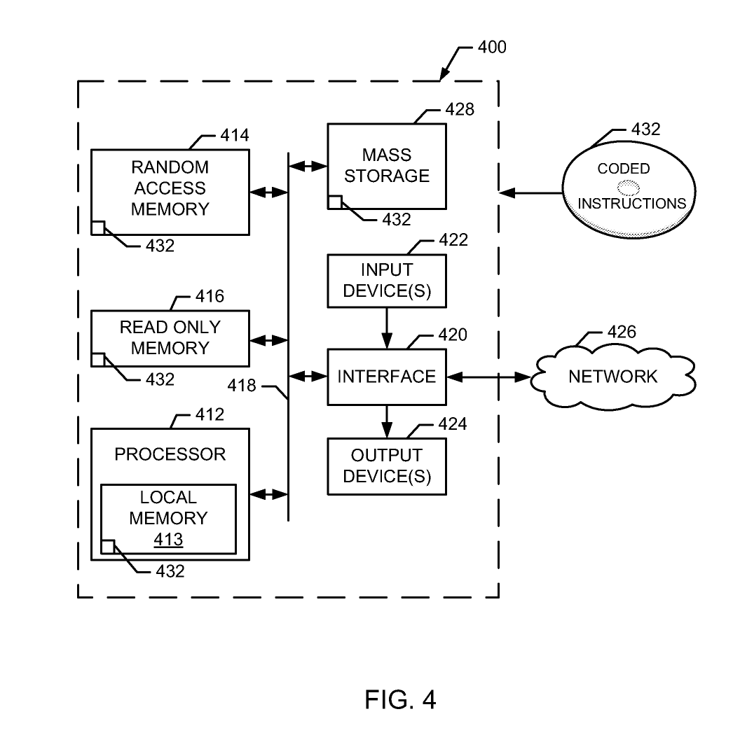

FIG. 4 is a block diagram of an example processor system 410 that may be used to implement systems and methods described herein. As shown in FIG. 4, the processor system 410 includes a processor 412 that is coupled to an interconnection bus 414. The processor 412 may be any suitable processor, processing unit, or microprocessor, for example. Although not shown in FIG. 4, the system 410 may be a multi-processor system and, thus, may include one or more additional processors that are identical or similar to the processor 412 and that are communicatively coupled to the interconnection bus 414.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 may include any desired type of volatile and/or non-volatile memory such as, for example, static random access memory (SRAM), dynamic random access memory (DRAM), flash memory, read-only memory (ROM), etc. The mass storage memory 425 may include any desired type of mass storage device including hard disk drives, optical drives, tape storage devices, etc.

The I/O controller 422 performs functions that enable the processor 412 to communicate with peripheral input/output (“I/O”) devices 426 and 428 and a network interface 430 via an I/O bus 432. The I/O devices 426 and 428 may be any desired type of I/O device such as, for example, a keyboard, a video display or monitor, a mouse, etc. The network interface 430 may be, for example, an Ethernet device, an asynchronous transfer mode (“ATM”) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks may be integrated within a single semiconductor circuit or may be implemented using two or more separate integrated circuits.

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system comprising:
a medical image viewer configured to:
receive a request for a medical image study display at a browser on a client device;
determine a size of the image study;
determine available space on the client device for image data storage;
determine a starting point for display of the image study via the browser; and
pre-load one or more images on the client device based on the starting point, image study size, and available space on the client device.

2. The system of claim 1, wherein the medical image viewer is further configured to monitor viewing of the images at the client browser to determine when an endpoint of the pre-loaded one or more images nears, and wherein the medical image viewer is to purge at least a portion of the pre-loaded images to pre-load additional images in the image study based on the endpoint.

3. The system of claim 2, wherein the medical image viewer is to purge one or more pre-loaded images furthest from an image being displayed via the client browser.

4. The system of claim 1, wherein the medical image viewer is further configured to identify a viewport display size at the client device and resize a first image for display via the client browser according to the viewport display size.

5. The system of claim 4, wherein the medical image viewer is further configured to transmit lossless original pixel data corresponding to the first image to replace the resized image once the transmission of the lossless original pixel data has been received at the client device.

6. The system of claim 5, wherein the lossless original pixel data replaces the lower resolution resized image data when the resized image data is manipulated by a user via the client browser.

7. The system of claim 4, wherein the viewport display size is received with the request for image study display.

8. A tangible computer-readable storage medium including computer program code to be executed by a processor, the computer program code, when executed, to implement a method comprising:
receiving a request for a medical image study display at a browser on a client device;
determining a size of the image study;
determining available space on the client device for image data storage;
determining a starting point for display of the image study via the browser; and
pre-loading one or more images on the client device based on the starting point, image study size, and available space on the client device.

9. The computer-readable storage medium of claim 8, wherein in the method further comprises monitoring viewing of the images at the client browser to determine when an endpoint of the pre-loaded one or more images nears, and purging at least a portion of the pre-loaded images to pre-load additional images in the image study based on the endpoint.

10. The computer-readable storage medium of claim 9, wherein purging comprises purging one or more pre-loaded images furthest from an image being displayed via the client browser.

11. The computer-readable storage medium of claim 8, wherein the method further comprises identifying a viewport display size at the client device and resizing a first image for display via the client browser according to the viewport display size.

12. The computer-readable storage medium of claim 11, wherein the method further comprises transmitting lossless original pixel data corresponding to the first image to replace the resized image once the transmission of the lossless original pixel data has been received at the client device.

13. The computer-readable storage medium of claim 12, wherein the lossless original pixel data replaces the lower resolution resized image data when the resized image data is manipulated by a user via the client browser.

14. The computer-readable storage medium of claim 11, wherein the viewport display size is received with the request for image study display.

15. A method comprising:
receiving a request for a medical image study display at a browser on a client device;
determining a size of the image study;
determining available space on the client device for image data storage;
determining a starting point for display of the image study via the browser; and
pre-loading one or more images on the client device based on the starting point, image study size, and available space on the client device.

16. The method of claim 15, further comprising monitoring viewing of the images at the client browser to determine when an endpoint of the pre-loaded one or more images nears, and purging at least a portion of the pre-loaded images to pre-load additional images in the image study based on the endpoint.

17. The method of claim 16, wherein purging comprises purging one or more pre-loaded images furthest from an image being displayed via the client browser.

18. The method of claim 15, further comprising identifying a viewport display size at the client device and resizing a first image for display via the client browser according to the viewport display size.

19. The method of claim 18, further comprising transmitting lossless original pixel data corresponding to the first image to replace the resized image once the transmission of the lossless original pixel data has been received at the client device.

20. The method of claim 19, wherein the lossless original pixel data replaces the lower resolution resized image data when the resized image data is manipulated by a user via the client browser.
